(19) United States
(12) Patent Application Publication
(10) Pub. No.: US 2011/0074068 A1
(43) Pub. Date: Mar. 31, 2011

(54) METHOD FOR SINTERING ANHYDROUS CALCIUM SULFATE AS BIOMEDICAL MATERIAL

(76) Inventor: YU-HSUEH LIN, TAIPEI CITY (TW)

(21) Appl. No.: 12/783,890

(22) Filed: May 20, 2010

(30) Foreign Application Priority Data
Sep. 30, 2009 (TW) 098133171

(51) Int. Cl. C04B 35/64

(52) U.S. Cl. 264/638

(57) ABSTRACT

A method for sintering anhydrous calcium sulfate material as biomedical material, includes the steps of: (a) preparing the anhydrous calcium sulfate material; (b) mixing the anhydrous calcium sulfate material with a sintering-support agent thoroughly to obtain a mixture waited for sintering; (c) die-pressing the mixture into a predetermined shape; and (d) executing a heat treatment onto the mixture to make the mixture be sintered to form the biomedical material having the predetermined shape.

This application claims the benefit of the Taiwan Patent Application Serial NO. 098133171, filed on Sep. 30, 2009, the subject matter of which is incorporated herein by reference.

### BACKGROUND OF THE INVENTION

1. Field of the Invention

The present invention relates to a sintering method for forming biomedical material consisting of calcium, more particularly to a method for sintering anhydrous calcium sulfate as biomedical material.

2. Description of the Prior Art

In human body, the skeletal system supports the skull, two legs and two hands, hence the body. The skeletal system generally consists of fused and individual bones formed from osteoblast cell and which includes composite material consisting of calcium phosphate (Ca₃(PO₄)₂). In our actual life, the skeletal system may unfortunately have some disadvantages since birth and the body function ability decreases as our age gets older, leading to fragility fracture of the skeleton. The skeletal system of the human body may encounter fatigue similar to mechanical fatigue due to long time of hard labor. In case, the human body is impacted mechanically (like during participation in sport or accidents), the skeletal system may be injured.

Due to old age, the mechanical impact or fatigue, the interior of the skeletal system and the joints between bones to permit movement are liable to fragility fracture (like broken of bones). If the condition is aggravated, human activity is restricted and the broken sharp pieces may pierce through the other stem cells or the nervous system causing unbearable pain. Therefore, some special medical treatment is required to immobilize the fractured bones during the convalescence. A bone graft transplant is commonly used to repair the defect ones. Presently, two bone transplant methods are available depending on the initial source of bone graft, namely: (i) autologous transplant method and (ii) allograft transplant method.

In the autologous transplant, the transplant bone graft generally comes from the skeletal system of the patient. As a rule, this method provides the outmost safety and effective result to the patient. The bone graft can be extracted from the patient is limited and the person undergoing the autologous transplant is often left with a surgical mark or scar, thereby causing the patient psychologically unsecure and mentally discomfort. Therefore, it is relatively difficult to use autologous transplant for bone grafting to repair the defected bone part.

In the allograft transplant, the transplant bone graft comes from the dead persons and the bone grafts are generally stored in Bone and Tissue Bank (special refrigerator). In practice, this method brings some disadvantages; such as one cannot be sure whether the bone grafts are properly maintained or the qualified standard of the bone bank and it is relatively difficult to trace the deceased person. Moreover, one cannot rest assure whether the bone graft is free from virus or diseases (like hepatitis and AIDS).

As mentioned above, there is no alternative but a bone graft substitute method is urgently needed to overcome the disadvantages of the prior methods. Under these guiding principles, the world (including Taiwan, Asia, Europe and America) leading medicine companies are conducting researches to develop an appropriate bone graft substitute method.

Since 1996, the US FDA (Food and Drug Administration) has passed 168 items of bone graft substitution, among which 108 items generally include calcium phosphate [the principle components being HAP (hydroxy-apatite), TCP (tri-calcium phosphate), de-collagen mineralized bone, collagen gel, bio-glass and polylactic substance], 36 items including DBM (demineralized bone matrix) products [including mainly DBM, added calcium sulfate hemihydrate, collagen gel, bio-glass, composite material (polylactic substance)] while 23 items generally include calcium sulfate. The last item includes collagen product.

As for calcium sulfate hemihydrate products, they are produced under the normal room temperature, since calcium sulfate hemihydrate products cannot be sintered under the heat treatment, thereby failing to form its shape. Moreover the calcium sulfate hemihydrate products are mechanically weak, thereby restricting the application of these products.

Moreover, in case of replacing anhydrous calcium sulfate material for the calcium sulfate hemihydrate material, a biomedical material can be obtained after undergoing a low heat treatment. But the biomedical material thus obtained may have low sintering ability, low mechanical strength and low bio compatibility, thereby unabling to control the degradation of calcium sulfate amount once transplanted into a human body and thus the biomedical material has low commercial value.

### SUMMARY OF THE INVENTION

In the prior art technology, the hemihydrate is unable to form into shape and therefore is weak mechanically. In case of replacing anhydrous calcium sulfate material with the calcium sulfate hemihydrate material, the biomedical material may have low sintering ability, low mechanical strength and low bio compatibility, thereby unabling to control the degradation of calcium sulfate amount once transplanted into a human body.

Therefore, the main object of the present invention is to provide a method of sintering anhydrous calcium sulfate as biomedical material, wherein the calcium sulfate hemihydrate is replaced by the anhydrous calcium sulfate. At the same time, a sintering-support agent is searched to augment the sintering ability during the heat treating process.

The second object of the present invention is to provide a method of sintering anhydrous calcium sulfate as biomedical material, wherein the biomedical material thus produced has relatively strong mechanical strength.

The third object of the present invention is to provide a method of sintering anhydrous calcium sulfate as biomedical material, wherein the biomedical material thus produced has relatively fine bio compatibility.

The fourth object of the present invention is to provide a method of sintering anhydrous calcium sulfate as biomedical material, wherein the biomedical material thus produced has low degradation once transplanted into a human body.

In accordance with the method of the present invention for sintering anhydrous calcium sulfate as biomedical material including the steps: (a) preparing an anhydrous calcium sulfate material; (b) mixing the anhydrous calcium sulfate material with a sintering-support agent thoroughly to obtain a mixture waited for sintering; (c) die-pressing the mixture waited for sintering; and (d) executing a heat treatment onto the mixture to make the mixture be sintered to form the biomedical material. The sintering-support agent is composed of a first additive and a second additive, the first additive being composed of calcium phosphate (Ca₃(PO₄)₂), the second additive being composed of at least one from a group consisting of sodium carbonate (Na₂CO₃), calcium oxide (CaO) and silicon dioxide (SiO₂).

The anhydrous calcium sulfate occupies P % of the weight, the sintering-support agent occupies Q % of the weight. Preferably, P=90 ˜98, Q=2˜10, P+Q=100, and when P=98, the biomedical material meets the standard quality for treatment.

Moreover, when the second additive is composed of silicon dioxide, the constitution of the calcium phosphate and the silicon dioxide can be increased in order to control the degradation of calcium sulfate once transplanted into the human body. It is noted that the more the calcium phosphate, the greater the degradation becomes once transplanted into the human body. The more the silicon dioxide, the smaller the degradation becomes once transplanted into the human body.

In contrast to the prior art technology, anhydrous calcium sulfate material is directly applied in the present sintering method instead of the hemihydrate. The experiment proves that the biomedical material thus obtained has relatively large density and does not easily deform in shape, in addition to owning strong mechanical strength and fine folding resistant strength. The biomedical material produced according to the present sintering method meets the ASTM F813-07 standard and has enhanced growing rate during the osteoblast-cell culture. It also has fine bio compatibility. Moreover, the simulating experiment proves that when the second additive is composed of silicon dioxide, the lesser the silicon dioxide, the greater the degradation becomes once transplanted into the human body. In contrast, the more the silicon dioxide, the smaller the degradation becomes once transplanted into the human body.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows the method of the present invention for sintering the first to twelfth embodiments of anhydrous calcium sulfate as biomedical material;

FIGS. 2A to 2C shows a density table of the biomedical material after heat treatment for the first to fourth embodiments of the present invention;

FIGS. 3A to 3C show a folding resistant strength table of the biomedical material after heat treatment for the first to twelfth embodiments of the present invention;

FIG. 4 is a picture illustrating steoblast cell viability according to ASTM F813-07 (Standard Practice for Direct Contact Cell Culture Evaluation of Material for Medical Devices) and seen under the scanning electron microscope;

FIG. 5 is a picture illustrating steoblast cell viability according to ASTM F813-07 (Standard Practice for Direct Contact Cell Culture Evaluation of Material for Medical Devices) of the first embodiment and is seen under the scanning electron microscope;

FIG. 6 is a picture illustrating osteoblast cell viability according to ASTM F813-07 (Standard Practice for Direct Contact Cell Culture Evaluation of Material for Medical Devices) of the second embodiment and is seen under the scanning electron microscope;

FIG. 7 is a picture illustrating osteoblast cell viability according to ASTM F813-07 (Standard Practice for Direct Contact Cell Culture Evaluation of Material for Medical Devices) of the third embodiment and is seen under the scanning electron microscope; and

FIG. 8 is a diagram of test carried out by using simulating humoral for illustrating degradation of osteoblast cell in the present invention.

### DETAILED DESCRIPTION OF THE PREFERRED EMBODIMENTS

The method of the present invention for sintering anhydrous calcium sulfate as biomedical material is widely applied for production of treatment devices. More specifically, the biomedical material is used for bone graft substitution for rapid patching of fractured bone and development. In the following, four embodiments are illustrated for better understanding of the present invention.

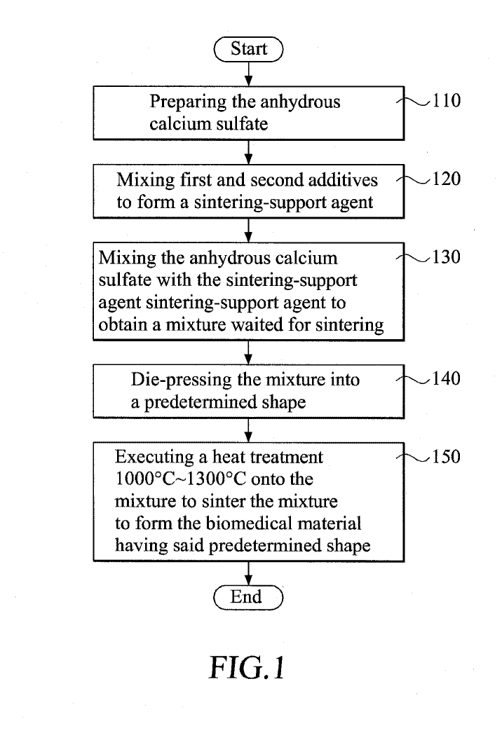

FIG. 1 shows the method of the present invention for sintering anhydrous calcium sulfate as biomedical material of the first to twelfth embodiments. As illustrated, (step 110) an anhydrous calcium sulfate material is prepared. After which, first an second additives are mixed together so as to obtain a sintering-support agent (step 120), wherein the first additive mainly consists of calcium phosphate (Ca₃(PO₄)₂) while the second additive consists of at least one from a group consisting of sodium carbonate (Na₂CO₃), calcium oxide (CaO) and silicon dioxide (SiO₂).

In the first, fifth and ninth embodiments, the second additive is composed of sodium carbonate (Na₂CO₃) mainly. In the second, sixth and tenth embodiments, the second additive is composed of calcium oxide (CaO) mainly. In the third, fourth, seventh, eighth, eleventh and twelfth embodiments, the second additive is composed of silicon dioxide (SiO₂) mainly.

To be more specific, in the first embodiment, the main component (in weight) being 98% of anhydrous calcium sulfate material+1.48% of calcium phosphate (Ca₃(PO₄)₂)+0.52% of sodium carbonate (Na₂CO₃). In the second embodiment, 98% of anhydrous calcium sulfate material+1.76% of calcium phosphate (Ca₃(PO₄)₂)+0.24% of calcium oxide (CaO). In the third embodiment, 98% of anhydrous calcium sulfate material+0.4% of calcium phosphate (Ca₃(PO₄)₂)+1.6% of silicon dioxide (SiO₂). In the fourth embodiment, 98% of anhydrous calcium sulfate material+1.6% of calcium phosphate (Ca₃(PO₄)₂)+0.4% of silicon dioxide (SiO₂).

In the fifth embodiment, 95% of anhydrous calcium sulfate material+3.8% of calcium phosphate (Ca₃(PO₄)₂)+1.2% of sodium carbonate (Na₂CO₃). In the sixth embodiment, 95% of anhydrous calcium sulfate material+3.52% of calcium phosphate (Ca₃(PO₄)₂)+1.48% of calcium oxide (CaO). In the seventh embodiment, 95% of anhydrous calcium sulfate material+1.8% of calcium phosphate (Ca₃(PO₄)₂)+3.2% of silicon dioxide (SiO₂). In the eighth embodiment, 95% of anhydrous calcium sulfate material+3.6% of calcium phosphate (Ca₃(PO₄)₂)+1.4% of silicon dioxide (SiO₂).

In the ninth embodiment, 90% of anhydrous calcium sulfate material+6.96% of calcium phosphate (Ca₃(PO₄)₂)+3.04% of sodium carbonate (Na₂CO₃). In the tenth embodiment, 90% of anhydrous calcium sulfate material+6.76% of calcium phosphate (Ca₃(PO₄)₂)+3.24% of calcium oxide (CaO). In the eleventh embodiment, 90% of anhydrous calcium sulfate material+3.6% of calcium phosphate (Ca₃(PO₄)₂)+6.4% of silicon dioxide (SiO₂). In the twelfth embodiment, 90% of anhydrous calcium sulfate material+6.8% of calcium phosphate (Ca₃(PO₄)₂)+3.2% of silicon dioxide (SiO₂).

The sintering-support agent formed according to the step (S120) is mixed thoroughly with the anhydrous calcium sulfate material so as to obtain a mixture waited for sintering (step 130).

Finally, and according to (step 140): the mixture is die-pressed into a predetermined shape and the latter is to undergo a heat treatment of the temperature 1000° C.˜1300° C. (the first embodiment is 1000° C.˜1100° C.), thereby sintering the mixture so as to obtain the biomedical material in the step (150).

In practical application, the weight of anhydrous calcium sulfate material is P %, the weight of sintering-support agent is Q %. Neglecting and without considering the unavoidable impurity of the substances, when P=90˜98, Q=2˜10, P+Q=100, wherein, when P=98, the biomedical material formed according to the sintering method of the present invention meets the standard quality for treatment, i.e., the biomedical material is compatible to the treatment standard of those advanced countries.

Preferably, when the weight of the first additive is Q1%, then the weights of sodium carbonate (Na₂CO₃), calcium oxide (CaO) and silicon dioxide (SiO₂) respectively are Q2%, Q3% and Q4%. Neglecting and without considering the unavoidable impurity of the substances, when Q1>0, Q2+Q3+Q4>0, Q1+Q2+Q3+Q4=2˜10. More specifically, when Q1=0.4˜6.96, Q2=0˜3.04, Q3=0˜3.24 and Q4=0˜6.4 respectively.

In order to prove the sintering ability, mechanical strength, bio-compatibility and the density of calcium sulfate in the biomedical material once transplanted into a human body, the anhydrous calcium sulfate products [herein called the “anhydrous calcium sulfate” and into which the sintering-support agent is added] of the present invention relative to the prior calcium sulfate hemihydrate [where sintering-support agent is excluded], an experiment is carried out after the heat treatment using the first to twelfth embodiments of the biomedical material according to the present invention.

After the heat treatment, the first to fourth embodiments are further tested using simulating humoral for illustrating degradation of osteoblast cell in human body, the bone density, osteoblast graft cell viability.

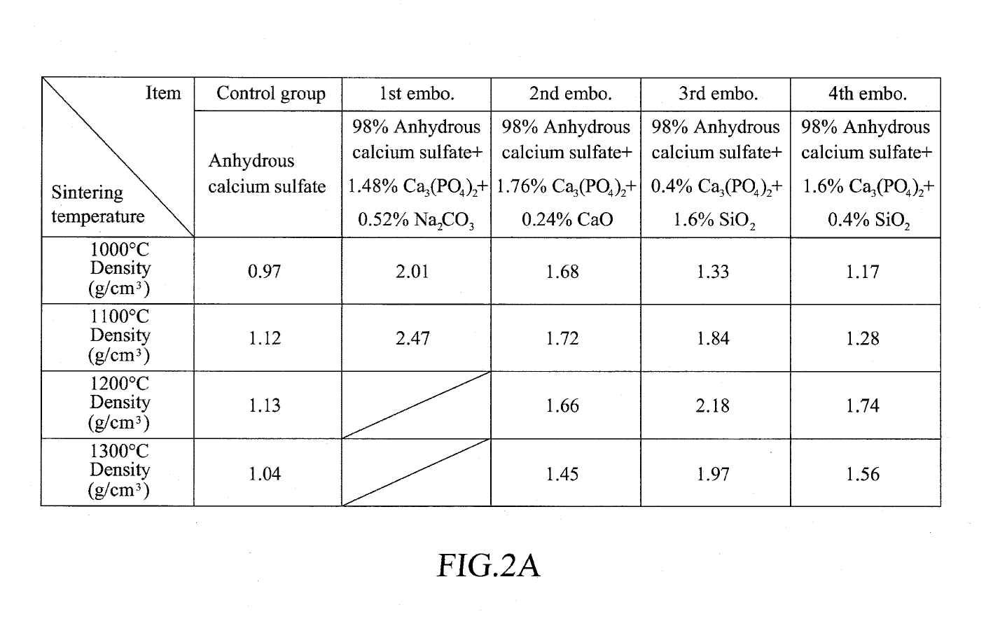

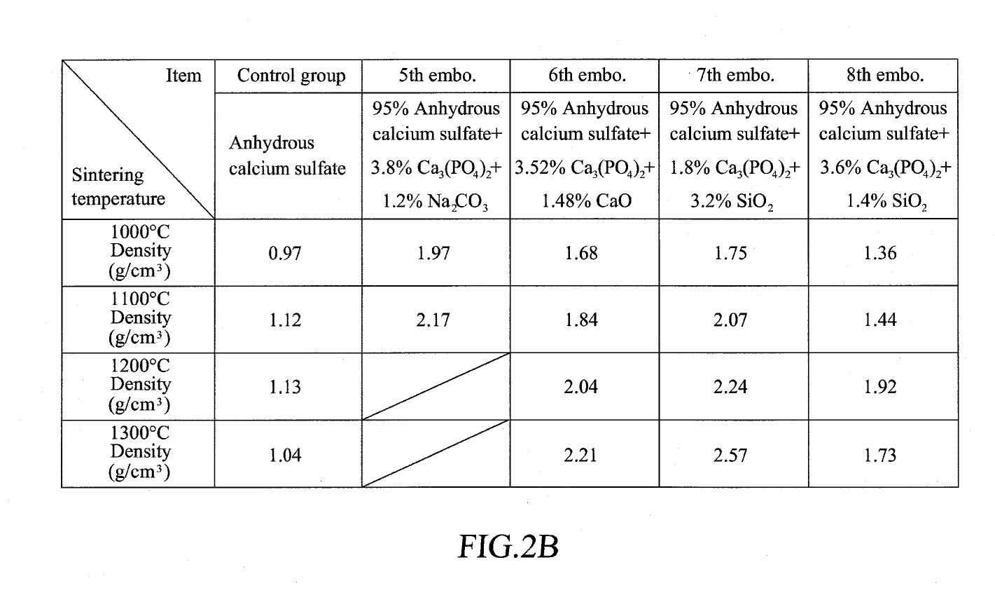

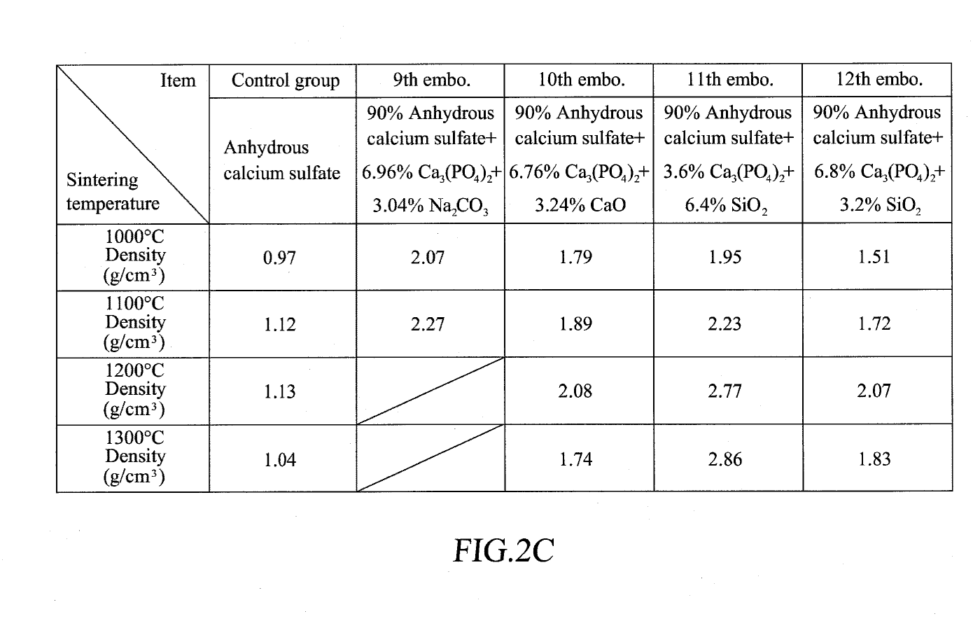

Referring to FIGS. 1, 2A to 2C, wherein FIGS. 2A to 2C show a density table of the biomedical material after heat treatment for the first to twelfth embodiments of the present invention. As illustrated in FIG. 1 and according to the step 140, the mixture of the first to twelfth embodiments are die-pressed into plate form and is heat-treated, thereby obtaining the biomedical material (consisting of anhydrous calcium sulfate) in rounded plate formation.

During the heat treatment, the temperature of the mixture (in rounded plate form) of the first to twelfth embodiments is increased every min by 5° C. according to the gradient of temperature to the designated temperature (1000° C., 1100° C., 1200° C., and 1300° C.) for the time period of 5 hrs, thereby obtaining the biomedical materials of the first to fourth embodiments. In addition, the anhydrous calcium sulfate in column 1 of FIG. 2 can be similarly treated.

Under the similar treatment process and under the same principles, the biomedical material (prior art) in column 1 is relatively soft such that when moving the biomedical material from one place to the other with the assistance to a pair of tongs, the material may crack within the tongs, and the material has a lower density degree when compared to the biomedical plates of the first to fourth embodiments.

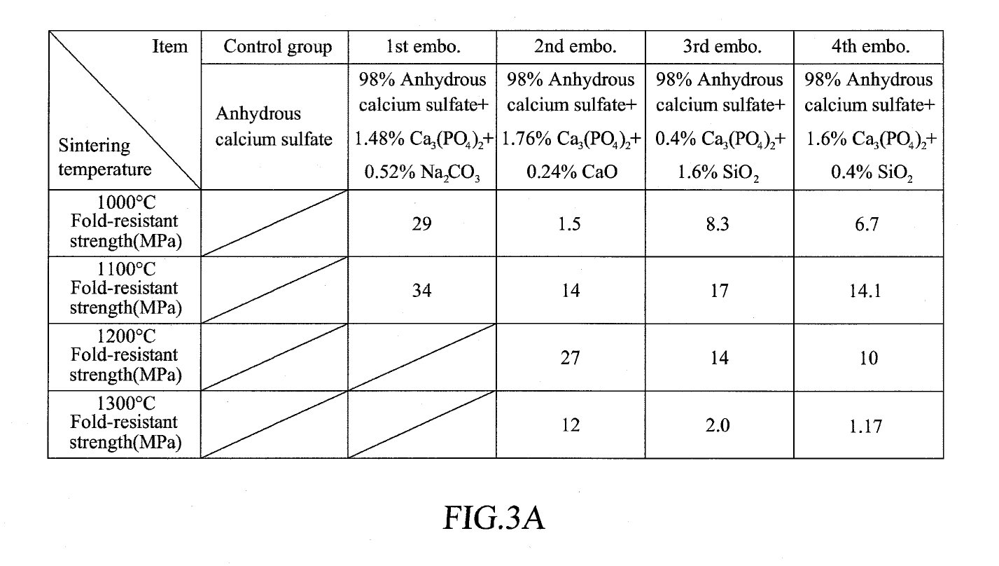

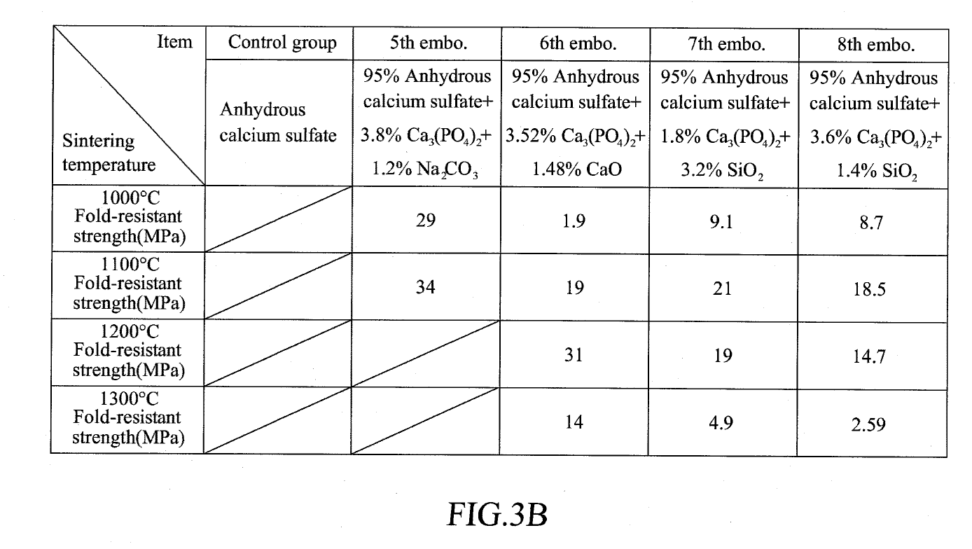

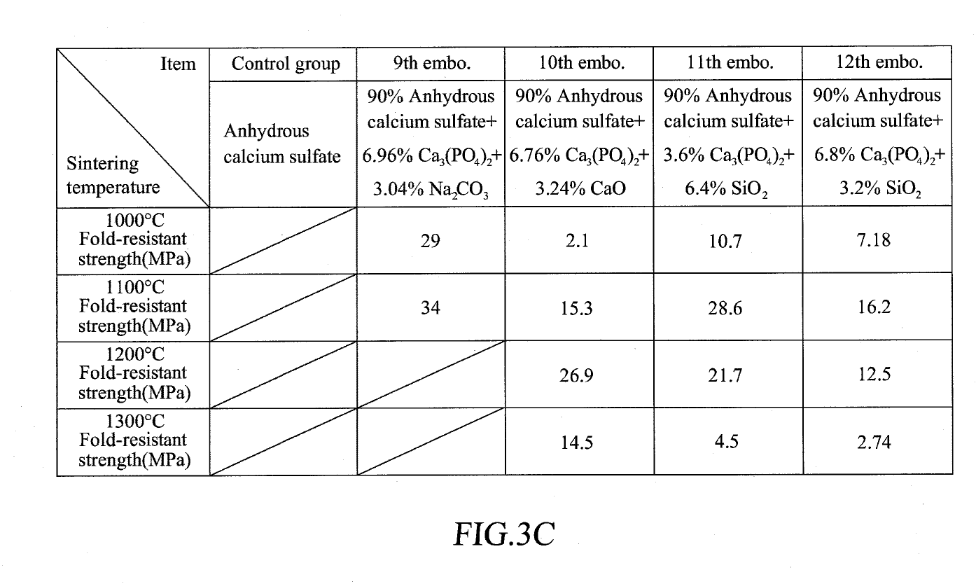

Referring to FIGS. 1, 3A to 3C, wherein FIGS. 3A to 3C show a table of folding resistant strength of the biomedical material after heat treatment for the first to twelfth embodiments of the present invention. Since the prior art biomedical plate (consisting of anhydrous calcium sulfate) treated according to the present sintering method is liable to crack so that no test can be carried out in order to find out the folding resistant strength of the prior art biomedical plate. A conclusion can be make that the biomedical plate of the first to twelfth embodiments has greater mechanical strength when compared to the prior art biomedical plate (treated according to the sintering method of the present invention) shown column 1 in FIG. 3.

The experiment further proves that when the method for sintering anhydrous calcium sulfate as biomedical plate is carried out under the temperature 1100° C.˜1200° C., the biomedical plate has greater folding resistant strength that of the prior art biomedical plate. In the first embodiment, the sintering-support agent consists of 1.48% of calcium phosphate (Ca₃(PO₄)₂)+0.52% of sodium carbonate (Na₂CO₃). The biomedical plate achieved through 1100° C. heat-treatment has the folding resistant strength of 34 MPa. In the fifth embodiment, the sintering-support agent consists of 3.8% of calcium phosphate (Ca₃(PO₄)₂)+1.2% of sodium carbonate (Na₂CO₃.). The biomedical plate achieved through 1100° C. heat-treatment has the folding resistant strength of 34 MPa. Thus, the biomedical plate is regarded as the anhydrous calcium sulfate ceramic with a resisting strength greater than 34 MPa.

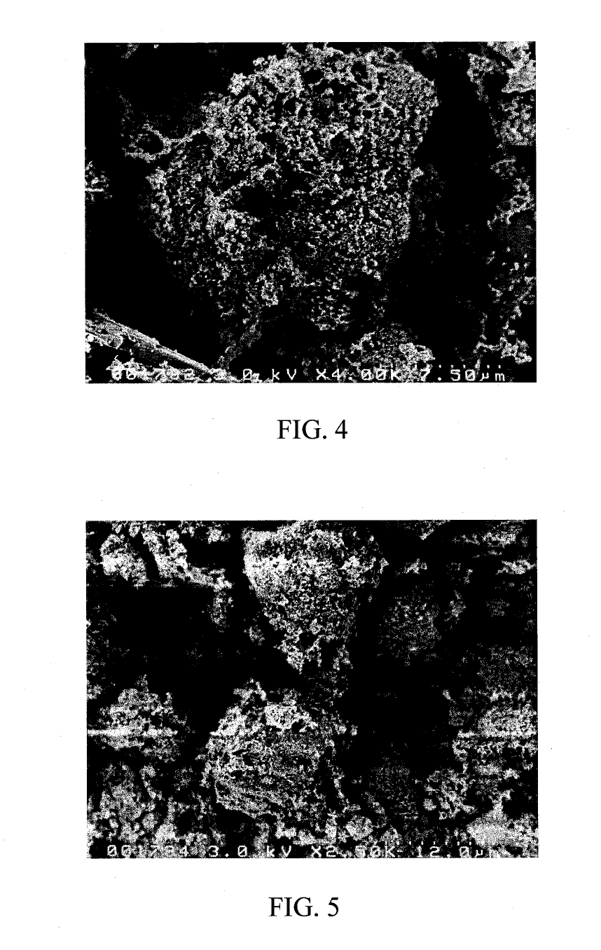

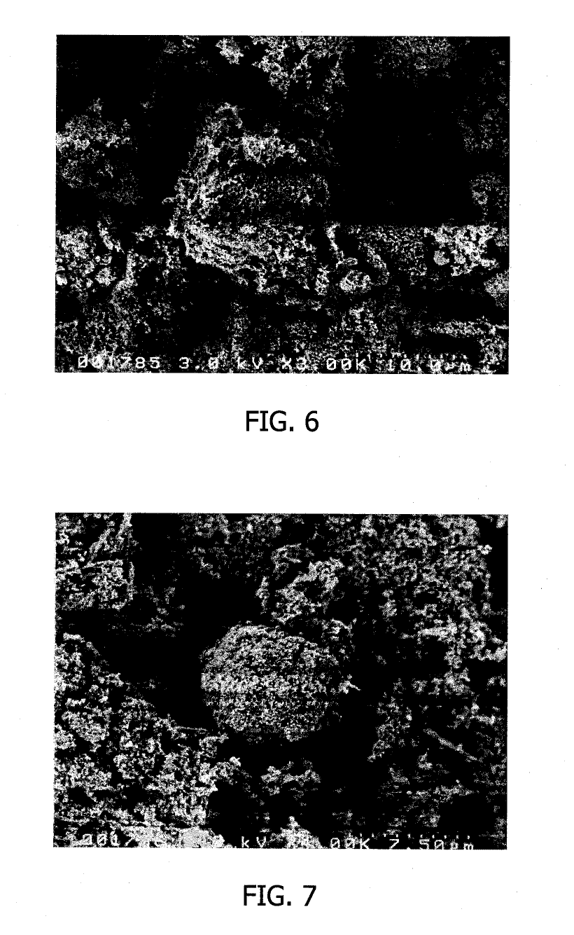

Referring to FIGS. 4 to 7, wherein FIG. 4 is a picture illustrating osteoblast cell viability according to ASTM F813-07 standard and seen under the SEM (scanning electron microscope); FIG. 5 is a picture illustrating osteoblast cell viability according to ASTM F813-07 of the first embodiment and is seen under the SEM (scanning electron microscope); FIG. 6 is a picture illustrating osteoblast cell viability according to ASTM F813-07 of the second embodiment and is seen under the SEM (scanning electron microscope); and FIG. 7 is a picture illustrating osteoblast cell viability according to ASTM F813-07 of the third embodiment and is seen under the SEM (scanning electron microscope).

In ASTM F813-07 standard, during osteoblast cell culture, it requires 5 days to carry out the test, wherein, the data are observed and recorded on the first, third and fifth days respectively. In the present invention, a cell similar to and having characteristics of osteoblast-like cell (MG-63) is used in the test. The osteoblast-like cell is liable to divide under metabolism into osteocyte consisting of inorganic salt like calcium sulfate. Then, osteoblast cell culture technology is applied to the biomedical material to test in vitro to find out the physiological condition (like adhesion, proliferation, differentiation and mineralization). At the same time, a toxicity test can also be carried out for the biomedical plate of the present invention.

As can be seen in FIG. 4, the osteoblast-like cell viability in the biomedical material does not increase vividly for the earlier 5 days. From FIG. 5, one can observe that in the biomedical material of the first embodiment, the number of the osteoblast-like cell increases vividly on the third day and on the fifth day, wherein, silk-like artificial legs and contacting phenomenon are visible.

Referring to FIG. 6, in the biomedical material of the second embodiment, silk-like artificial legs and contacting phenomenon are visible but the number of the osteoblast-like cell is not so much as in the biomedical material of the first embodiment in FIG. 5. As illustrated in FIG. 7, in the biomedical material of the third embodiment, silk-like artificial legs and contacting phenomenon are visible and the number the osteoblast-like cell ranges between the first and second embodiments.

Summarizing the aforesaid facts, conclusion can be drawn that the biomedical materials of the first, second or third embodiments are suitable for adhesion of the osteoblast-like cell when compared to that in column 1, wherein, the biomedical material of the first embodiment [98% of anhydrous calcium sulfate material+1.48% of calcium phosphate (Ca₃(PO₄)₂)+0.52% of sodium carbonate (Na₂CO₃)] is suitable for adhesion of the osteoblast-like cell.

Conclusion can be make that whether the biomedical material of the first, second or third embodiments is applied, it is more suitable than the prior art biomedical material as far as adhesion of the osteoblast-like cell is concerned and it has better bio-compatibility when compared to the prior art biomedical material. In addition, the biomedical material of the first, second or third embodiments shown in FIGS. 5 to 7 is free from toxicity.

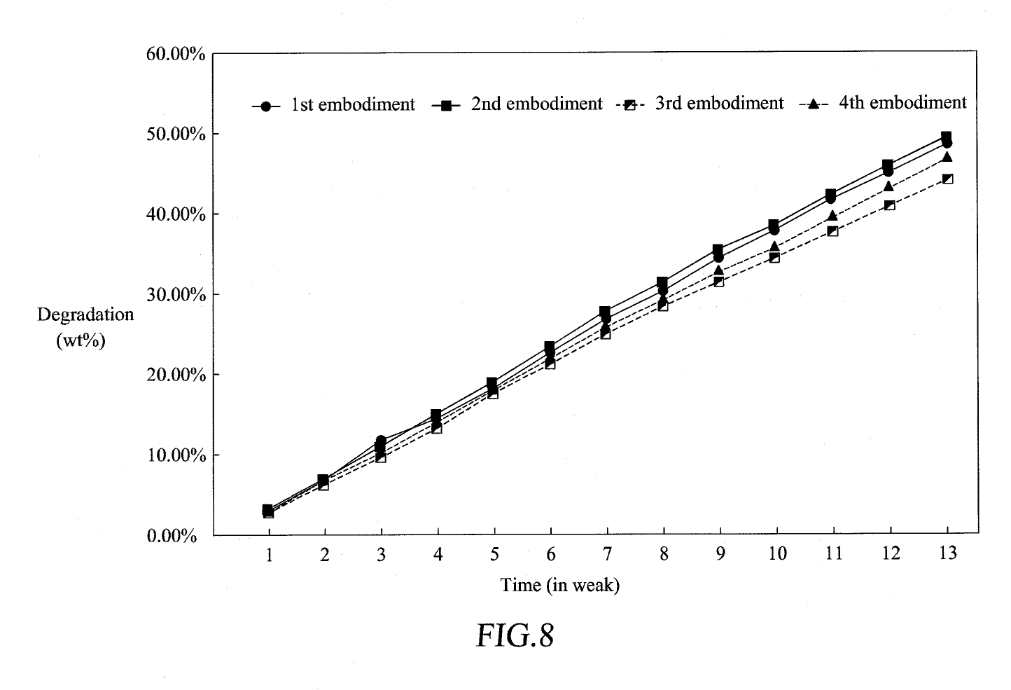

FIG. 8 is a diagram of a test carried out by using simulating humoral for illustrating degradation of steoblast cell in the first to fourth embodiments in the present invention under the ASTM F1609-08 Standard. From this test, one can observe the degradation of biomedical material once transplanted into the human body. When carrying out the degradation test, weight of the biomedical material of the first and third embodiment is firstly measured, and is immersed in 20 ml of a simulating Hank's solution (pH=7.1) under 37° C. for a period of one, two and three months respectively. For precise analysis, the degradation is recorded for a period of one week.

Under the ASTM F 1609-08 Standard, increase in the weight of calcium salt is beneficial to osteointegration. The biomedical plates (namely Cz-11A and Cz-19A) of the first and fourth embodiments are immersed in the simulating Hank's solution and are measured for 5 decimal places in order to observe the variation and a degradation table is shown in FIG. 8. It is found the prior art biomedical plate cracks immediately once immersed into the simulating Hank's solution whereas when the biomedical plate of the four embodiments is immersed in the simulating Hank's solution, the weight of calcium salt increases after one day time (deposition of calcium salt increases).

One month after the test, the third embodiment [98% of anhydrous calcium sulfate material+0.4% of calcium phosphate (Ca₃(PO₄)₂)+1.6% of silicon dioxide (SiO₂)] and the fourth embodiment [98% of the common characteristic of respectively have degradation smaller than the first embodiment [98% of anhydrous calcium sulfate material+1.48% of Ca₃(PO₄)₂+0.52% of sodium carbonate (Na₂CO₃)] and the second embodiment [98% of anhydrous calcium sulfate material+1.76% of calcium phosphate (Ca₃(PO₄)₂)+0.24% of calcium oxide (CaO)]. From these basis facts, it can be deduced that the biomedical material of the third and fourth embodiments has small degradation of calcium sulfate once transplanted into the human body. As illustrated in FIG. 8, 10, the biomedical material of the first and second embodiment degrades to half after 90 days of transplant (time for degrading to 50%).

Further analysis proves that the third and fourth embodiments have a common characteristic of consisting anhydrous calcium sulfate material, calcium phosphate and silicon dioxide. Except the third embodiment has 1.6% of silicon dioxide while the fourth embodiment has 0.4% of silicon dioxide. From this basis, it can be deduced that the more the silicon dioxide, the smaller the degradation becomes once transplanted into the human body.

Therefore, in the step 120, prior to mixing the first and second additives into the sintering-support agent, it is to adjust the percentage of silicon dioxide (i.e., Q4) in the biomedical material which is to be transplanted into the human body. It is to increase the increase the percentage of Q4 when a smaller degradation is required. In contrast, it is to decrease the percentage of Q4 when a larger degradation is required.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for sintering anhydrous calcium sulfate as biomedical material, comprising the steps of:
(a) preparing the anhydrous calcium sulfate;
(b) mixing the anhydrous calcium sulfate with a sintering-support agent thoroughly to obtain a mixture waited for sintering;
(c) die-pressing the mixture into a predetermined shape; and
(d) executing a heat treatment onto the mixture to sinter the mixture into the biomedical material having said predetermined shape;
wherein, said sintering-support agent is composed of a first additive and a second additive, said first additive being composed of calcium phosphate (Ca₃(PO₄)₂), said second additive being composed of at least one from a group consisting of sodium carbonate (Na₂CO₃), calcium oxide (CaO) and silicon dioxide (SiO₂), the anhydrous calcium sulfate occupying weight of P %, said sintering-support agent occupying weight of Q %, wherein P=90˜98, Q=2˜10, P+Q=100, when P=98, the biomedical material meets the standard quality for treatment.

2. The method according to claim 1, wherein the step (b) further comprising a substep (b1): mixing said first and second additives so as to form said sintering-support agent.

3. The method according to claim 1, wherein in the step (d), said heat treatment is carried out within a temperature of 1000° C.˜1100° C.

4. The method according to claim 1, wherein when said second additive is composed of at least one from a group consisting of calcium oxide (CaO) and silicon dioxide (SiO₂), said heat treatment in the step (d) being carried out within a temperature of 1000° C.˜1300° C.

5. The method according to claim 1, wherein the biomedical material is anhydrous calcium sulfate ceramic with a resisting strength greater than 34 MPa.

6. The method according to claim 1, wherein said first additive occupies weight of Q1%, said sodium carbonate (Na₂CO₃), said calcium oxide (CaO) and said silicon dioxide (SiO₂) occupying weight of Q2%, Q3% and Q4% respectively, where Q1>0, Q2+Q3+Q4>0, and Q=Q1+Q2+Q3+Q4=2˜10.

7. The method according to claim 6, wherein said Q1=0.4˜6.96, said Q2=0˜3.04, said Q3=0˜3.24, Q4=0˜6.4.

8. The method according to claim 6, wherein the step (b) further comprising a substep (b2): adjusting percentage of Q4 depending on a preset degradation of the biomedical material to be transplanted into a human body, wherein the smaller the preset degradation the larger the percentage of Q4 becomes.
